(19) United States
(12) Patent Application Publication
(10) Pub. No.: US 2021/0183546 A1
(43) Pub. Date: Jun. 17, 2021

(54) MAGNETIC CALORIFIC COMPOSITE MATERIAL AND METHOD FOR MANUFACTURING THEREOF

(71) Applicant: Panasonic Intellectual Property Management Co., Ltd., Osaka (JP)

(72) Inventors: KAZUKI SAKAI, Osaka (JP); HIROAKI YOSHIDA, Osaka (JP)

(21) Appl. No.: 17/119,996

(22) Filed: Dec. 11, 2020

(30) Foreign Application Priority Data
Dec. 16, 2019 (JP) 2019-226601
Dec. 8, 2020 (JP) 2020-203579

(51) Int. Cl. H01F 1/01; C22C 13/00; C22C 32/00; C22C 1/03

(52) U.S. Cl. CPC H01F 1/015; C22C 13/00; C22C 2202/02; C22C 1/03; C22C 32/0089

(57) ABSTRACT

Provided is a magnetic calorific composite material containing a magnetic calorific material and an alloy binder having a melting point in a range of 100° C. to 150° C., in which a content of the alloy binder is 7.5 to 22.5 wt %.

### BACKGROUND

### 1. Technical Field

The present disclosure relates to a magnetic calorific composite material containing a magnetic calorific material and a binder, and a method for manufacturing thereof.

### 2. Description of the Related Art

In many vapor-compression heat pumps such as air conditioners or refrigerators, alternative fluorocarbons having a high global warming potential are used. At the MOP28 held in Kigali, Rwanda in 2016, a proposal to revise the Montreal Protocol to make alternative fluorocarbons subject to new regulations was adopted. As seen from this, considerations for the environment in this area are becoming more and more important. Based on this background, there is a demand for commercialization of new heat pumps with a lower environmental load.

In recent years, expectations for magnetic refrigeration technology have increased as candidates for environment-friendly and highly efficient refrigeration technology, and research and development of room temperature magnetic refrigeration technology has been actively carried out. The magnetic refrigeration technology is a refrigeration technology that uses a phenomenon (magnetic calorific effect) in which heat is generated when a magnetic field is applied to a magnetic calorific material which is a magnetic material, and the temperature drops when the magnetic field is removed. Since there is no need to use a refrigerant such as fluorocarbons, no compressor is required, and power is reduced, it is expected that both of no use of global warming substances and energy saving will be possible.

In order to effectively exchange heat between the magnetic calorific material and the refrigerant, it has been proposed to process the magnetic calorific material into a microchannel shape (Japanese Patent Unexamined Publication No. 2007-291437). In the process of manufacturing a microchannel, in order to form a crystal structure that easily exhibits a magnetic calorific effect, pulverization is performed after undergoing a process of melting, quenching, and heat treatment, and then compounding is performed by sintering. However, a part of the crystal structure is destroyed in the sintering process, and the magnetic calorific effect is reduced. Therefore, compounding means for lowering a sintering temperature by using an epoxy resin as a binder for the pulverized magnetic calorific material has been proposed (Japanese Patent Unexamined Publication No. 2014-95486).

### SUMMARY

A magnetic calorific composite material according to an aspect of the present disclosure contains a magnetic calorific material and an alloy binder having a melting point in a range of 100° C. to 150° C., in which a content of the alloy binder is 7.5 wt % to 22.5 wt %.

A method for manufacturing a magnetic calorific composite material according to an aspect of the present disclosure is a method for manufacturing a magnetic calorific composite material, which contains a magnetic calorific material and an alloy binder having a melting point in a range of 100° C. to 150° C., the method including: pressurizing a mixture of the magnetic calorific material and the alloy binder at a temperature in the range of 100° C. to 150° C. of the melting point of the alloy binder.

### BRIEF DESCRIPTION OF THE DRAWINGS

FIG. 1 is a cross-sectional photograph of a magnetic calorific composite material of the present disclosure;

FIG. 2A is a schematic view illustrating (1) a precursor preparation step in a step of manufacturing the magnetic calorific composite material of the present disclosure;

FIG. 2B is a schematic view illustrating (2) a magnetic calorific material preparation step in the step of manufacturing the magnetic calorific composite material of the present disclosure;

FIG. 2C is a schematic view illustrating (3) a pulverization step in the step of manufacturing the magnetic calorific composite material of the present disclosure;

FIG. 2D is a schematic view illustrating (4) a compounding step in the step of manufacturing the magnetic calorific composite material of the present disclosure;

FIG. 3A is a table showing a measurement result of properties of the magnetic calorific composite material according to Example 1 and Comparative Example 1 of the present disclosure;

FIG. 3B is a table showing the measurement result of properties of the magnetic calorific composite material according to Example 2 and Comparative Example 2 of the present disclosure; and

FIG. 3C is a table showing the measurement result of properties of the magnetic calorific composite material according to Example 3 and Comparative Example 3 of the present disclosure.

### DETAILED DESCRIPTIONS

Since a resin is used as a binder, thermal conductivity of the entire microchannel is lowered, and the performance of the magnetic refrigeration system is lowered. In the related art, in a compounding step of a magnetic calorific material, heating is performed to a high temperature (for example, 500° C. or higher), and a sintering reaction between powders is proceeded to realize compounding, but the magnetic calorific effect is deteriorated due to precipitation of phases having different magnetic properties (for example, precipitation of α-Fe) and the like.

An object of the present disclosure is to provide a magnetic calorific composite material in which a decrease in thermal conductivity and a decrease in the magnetic calorific effect are suppressed, and a method for manufacturing thereof.

Hereinafter, the magnetic calorific composite material and the method for manufacturing thereof in the present disclosure will be described with reference to the drawings depending on the necessity. However, more detailed description than necessary may be omitted. For example, the detailed description of already well-known matters or repeated description for substantially the same configuration may be omitted. This is to avoid unnecessary redundancy of the description and to facilitate the understanding of those skilled in the art.

The applicant provides the accompanying drawings and the following description for those skilled in the art to fully understand the present disclosure, and does not intend to limit the subject described in the claims therewith. It should be noted that various elements in the drawings are merely schematically and indicatively shown for the understanding of the present disclosure, and the appearance, dimensional ratio, and the like may differ from the actual ones.

### Magnetic Calorific Composite Material

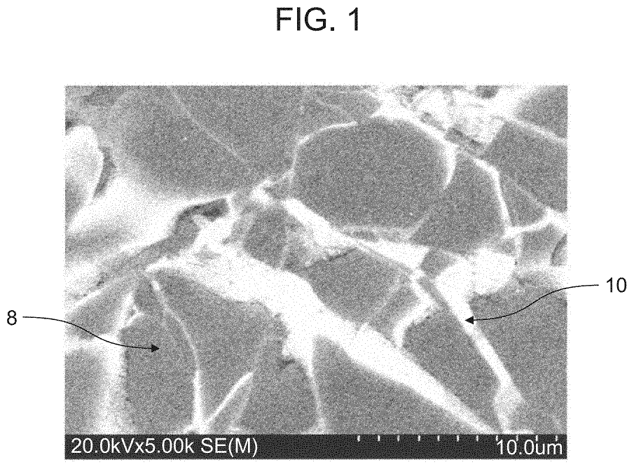

The magnetic calorific composite material in the present disclosure contains a magnetic calorific material, and an alloy binder having a melting point in a range of 100° C. to 150° C. (both inclusive). The magnetic calorific composite material has a structure in which an alloy binder is dispersed in the magnetic calorific material, and is composited by chemically or physically bonding the magnetic calorific materials to each other via the alloy binder. FIG. 1 shows a cross-sectional view of the magnetic calorific composite material of the present disclosure. A phase that is seen black represents an La(FeSi)₁₃-based magnetic calorific material, and a phase that is seen white represents an alloy binder.

### Magnetic Calorific Material

The magnetic calorific composite material can express the magnetic calorific effect by including an amount of the magnetic calorific material. Examples of the magnetic calorific material include, but are not limited to, magnetic calorific materials such as La(FeSi)₁₃-based material, MnAs-based material, MnFe(AsP)-based material, Gd₅(GeSi)₄-based material, and Ni—Mn—X-based material. According to the present disclosure, the magnetic calorific material may contain iron from a viewpoint of effectively suppressing the deterioration of properties due to the precipitation of a-Fe (a iron).

The amount of the magnetic calorific material is preferably La(FeSi)₁₃-based material from a viewpoint of expressing good thermal properties and magnetic properties. The La(FeSi)₁₃-based material is a material mainly made of La, Fe, and Si, and may contain other elements. The La(FeSi)₁₃-based material contains NaZn₁₃ crystal structure, and preferably contains a NaZn₁₃ crystal structure as a main phase. The La(FeSi)₁₃-based material may contain a crystal structure other than the NaZn₁₃ crystal structure or an amorphous structure.

The magnetic calorific material may be a La(FeSi)₁₃-based material, which is represented by the following formula (I):

La₁₋ₐAₐ(Fe_{b}B_{c}Si_{1-b-c})₁₃H_{d} (I)

In Formula (I), A may be a rare earth element, for example, at least one selected from the group consisting of cerium (Ce), praseodymium (Pr), and neodymium (Nd) element.

In Formula (I), B may be a 3d transition element, for example, at least one selected from the group consisting of manganese (Mn) and cobalt (Co).

In Formula (I), a may be 0 or more, 0.1 or more, 0.15 or more, or 0.25 or more. In addition, a may be 0.6 or less, 0.5 or less, 0.25 or less, or 0.1 or less, a is preferably 0≤a≤0.5.

In Formula (I), b may be 0.75 or more, 0.8 or more, 0.84 or more, or 0.88 or more. In addition, b may be 0.95 or less, 0.9 or less, 0.88 or less, or 0.85 or less, b is preferably 0.84≤b≤0.9.

In Formula (I), c may be 0 or more, 0.01 or more, 0.03 or more, or 0.05 or more. In addition, c may be 0.4 or less, 0.3 or less, 0.1 or less, or 0.05 or less, c is preferably 0≤c≤0.3.

In Formula (I), d may be 0.05 or more, 0.1 or more, 0.3 or more, or 0.75 or more. In addition, d may be 2.5 or less, 2.0 or less, 1.5 or less, or 1.0 or less, d is preferably 0.1≤d≤2.0.

In Formula (I), 1−b−c may be 0.05 or more, 0.08 or more, 0.1 or more, or 0.13 or more. In addition, 1−b−c may be 0.25 or less, 0.2 or less, 0.18 or less, or 0.13 or less, 1−b−c is preferably 0.1≤1−b−c≤0.13.

By using a magnetic calorific material having a composition in the above range, deterioration of properties due to compounding can be suitably suppressed.

### Alloy Binder Having a Melting Point of 150° C. or Lower

As the alloy binder contains the magnetic calorific composite material, the magnetic calorific material can be composited.

A melting point of the alloy binder may be 150° C. or lower, 148° C. or lower, 146° C. or lower, 144° C. or lower, 142° C. or lower, 140° C. or lower, 138° C. or lower, or 135° C. or lower. The melting point of the alloy binder may be 100° C. or higher, 110° C. or higher, 120° C. or higher, 130° C. or higher, 135° C. or higher, 140° C. or higher, 142° C. or higher, or 144° C. or higher.

The alloy binder may be an alloy containing Sn and one or more selected from the group consisting of In, Ag, Pb, and Cd. The alloy is preferably a binary system, a ternary system, or a quaternary system or more. With this, deterioration of properties due to compounding can be suitably suppressed.

The alloy binder may contain Sn in an amount of 40 wt % or more. The alloy binder may contain Sn in an amount of 20 wt % or more, 30 wt % or more, 40 wt % or more, 50 wt % or more, 60 wt % or more, 70 wt % or more, 80 wt % or more, or 90 wt % or more, and preferably contains 40 wt % or more. With this, deterioration of properties due to compounding can be suitably suppressed.

### Other Components

Depending on the necessity, the magnetic calorific composite material may contain other components such as other magnetic materials, other binders, other additives, and the like, in addition to these described above.

### Composition of Magnetic Calorific Composite Material

The magnetic calorific composite material contains at least the magnetic calorific material and the alloy binder, and may be substantially formed of the magnetic calorific material and the alloy binder.

An amount of the alloy binder in the magnetic calorific material complex may be more than 5 wt %, 7.5 wt % or more, 10 wt % or more, 12.5 wt % or more, 15 wt % or more, or 17.5 wt % or more, and preferably 7.5 wt % or more. The amount of the alloy binder in the magnetic calorific material complex may be less than 25 wt %, 22.5 wt % or less, 20 wt % or less, 17.5 wt % or less, 15 wt % or less, or 12.5 wt % or less, and preferably 22.5 wt % or less.

The magnetic calorific material may be 4.5 parts by weight or more, parts by weight or more, 7.5 parts by weight or more, 10 parts by weight or more, or 12.5 parts by weight or more with respect to 1 part by weight of the alloy binder. The magnetic calorific material may be 13 parts by weight or less, 10 parts by weight or less, 7.5 parts by weight or less, or 6 parts by weight or less with respect to 1 part by weight of the alloy binder.

The amount of other components in the magnetic calorific material complex is, for example, 10 wt % or less, 5 wt % or less, 2.5 wt % or less, or 1.0 wt % or less.

By having each component in the above range, deterioration of magnetic properties and deterioration of thermal conductivity can be suitably suppressed while maintaining the strength of the magnetic calorific material complex.

### Properties of Magnetic Calorific Composite Material

The thermal conductivity of the magnetic calorific composite material may be 4.5 W/mK or more, 5.0 W/mK or more, 5.5 W/mK or more, 6.0 W/mK or more, or 6.5 W/mK or more, and preferably 5.0 W/mK or more.

Vickers strength of the magnetic calorific composite material may be 155 N/mm² or more, 160 N/mm² or more, or 165 N/mm² or more, and preferably 160 N/mm² or more.

In a case where a Curie temperature of the magnetic calorific material before compounding is denoted as T₀, a Curie temperature of the magnetic calorific composite material may be T₀−4.0° C. or higher, T₀−2.0° C. or higher, T₀−1.0° C. or higher, or T₀−0.5° C. or higher, and preferably T₀−2° C. or higher.

In a case where a magnetic entropy change of the magnetic calorific material before compounding is denoted as ΔS₀, the Curie temperature of the magnetic calorific composite material may be ΔS₀−2.0 J/kgK or more, ΔS₀−1.5 J/kgK or more, ΔS₀−1.0 J/kgK or more, or ΔS₀−0.5 J/kgK or more, and preferably ΔS₀−1.0 J/kgK or more.

### Method of Manufacturing Magnetic Calorific Composite Material

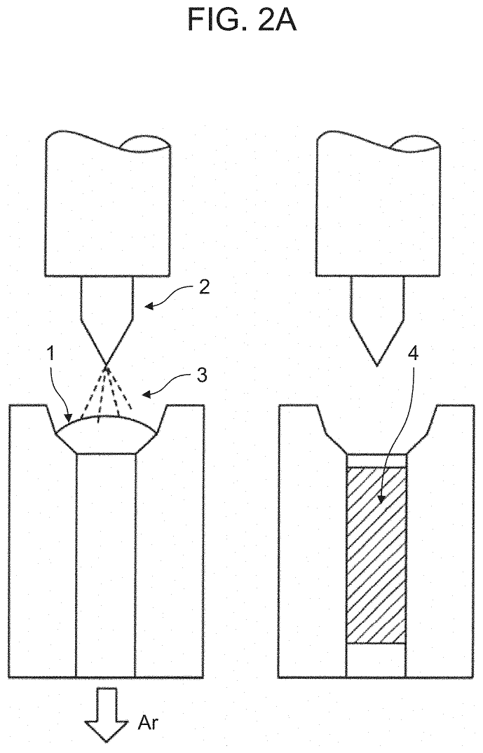

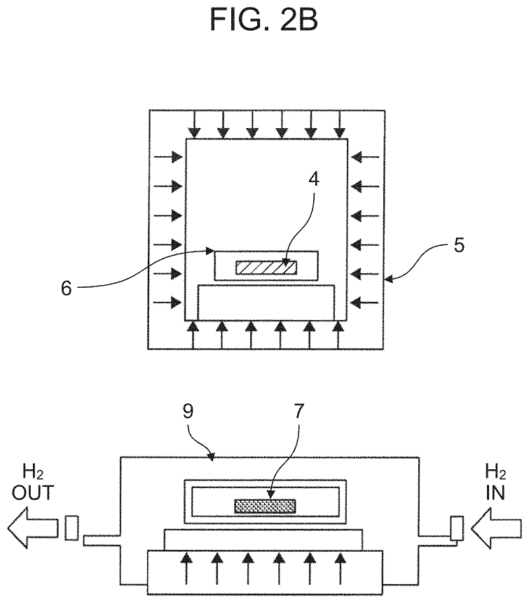

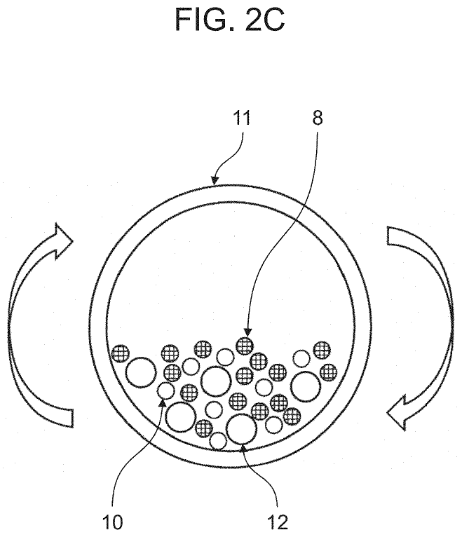

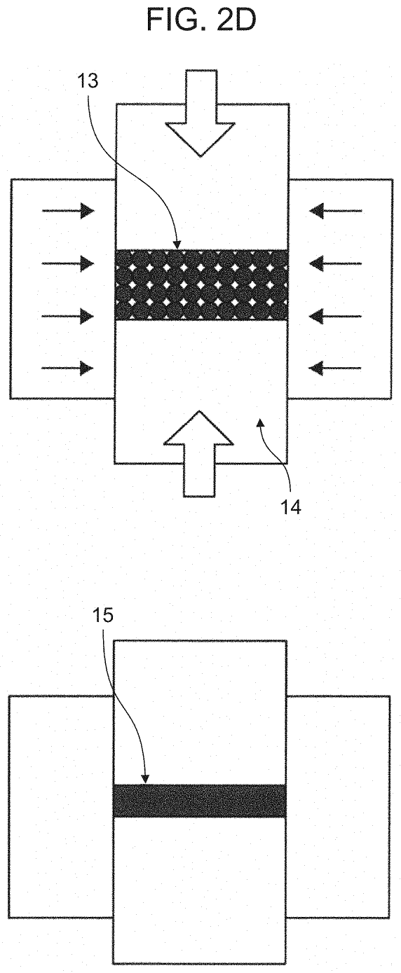

An exemplary embodiment of manufacturing processes of the magnetic calorific composite material of the present disclosure will be described with reference to FIGS. 2A to 2D. Since these figures are schematic views, there is a case where the size or the shape of each component differs from the actual one.

### (1) Precursor Preparation Step

In the precursor preparation step, a precursor of the magnetic calorific composite material is prepared. Precursor 4 of a magnetic calorific material can be prepared by blending raw material powder 1 of a single body in a predetermined ratio and performing a suction casting method. The suction casting method is a technique of sucking a material dissolved by arc discharge 3 generated from W electrode 2 into a mold in an inert gas atmosphere such as argon (Ar) and forming precursor 4 having a fine material structure. Raw material powder 1 preferably has a purity of 4N or more. In addition, since rare earths such as lanthanum (La), cerium (Ce), praseodymium (Pr), and neodymium (Nd) volatilize during dissolution, they may weigh about 1 to 20 atm % greater (for example, 7.5 to 12.5 atm %).

### (2) Magnetic Calorific Material Preparation Step

Precursor 4 generally does not have a NaZn₁₃ crystal structure. Therefore, it is possible to prepare intermediate material 7 having the NaZn₁₃ crystal structure by performing heat treatment on precursor 4 using muffle furnace 5.

It is preferable to vacuum-seal quartz tube 6 in order to prevent volatilization of rare earth elements when performing the heat treatment. A degree of vacuum at this time may be 100 Torr or less, for example, 10 Torr or less. A heating temperature may be 800° C. to 1,500° C., for example, 1,100° C. to 1,200° C. A heating time may be 6 to 48 hours, for example, 12 to 36 hours.

The Curie temperature of obtained intermediate material 7 is around −100° C. In order for use at room temperature, it is necessary to set the Curie temperature to 0° C. or higher, preferably 5° C. or higher, and more preferably 10° C. or higher. Therefore, by using raising the Curie temperature by increasing an inter-lattice distance of the NaZn₁₃ crystal structure, it is possible to obtain magnetic calorific material 8 in which hydrogen (H) is occluded in the crystal structure. Specifically, intermediate material 7 was put into tube furnace 9 filled with hydrogen and heated to occlude hydrogen. The heating temperature at this time may be 100° C. to 300° C., for example, 180° C. to 250° C. By controlling a heat treatment temperature, a hydrogen occlusion amount can be changed and the Curie temperature can be arbitrarily controlled.

### (3) Pulverization Step

A binder and an alloy are pulverized and mixed with obtained magnetic calorific material 8. A method of pulverization is not particularly limited, and a known method can be used. Pulverization and mixing may be performed at the same time.

For example, magnetic calorific material 8 and alloy 10 serving as a binder are placed in ball mill container 11, pulverized and mixed using a ball mill device to obtain alloy-containing magnetic calorific material powder 13. Depending on the type of device, a crushing time and crushing strength can be appropriately determined in order to obtain a desired particle size and the like. A particle size D₅₀ of an alloy-containing magnetic calorific material powder 12 may be 10 to 100 μm, for example, 25 to 75 μm, and preferably 40 to 60 μm.

### (4) Compounding Step

In the compounding step, alloy-containing magnetic calorific material powder 13 can be heated and pressurized by thermal press device 14 to prepare bulk-shaped magnetic calorific composite material 15. Although heating and pressurization may be performed separately, it is generally preferable to perform heating and pressurization at the same time.

The heating temperature is preferably 150° C. or lower, and preferably equal to or lower than the melting point of alloy 10. The heating temperature may be 100° C. or higher, 120° C. or higher, or 130° C. or higher. The heating temperature is preferably equal to or lower than the melting point of alloy 10. The heating temperature of alloy 10 is 0.75 times or more, 0.80 times or more, 0.85 times or more, 0.90 times or more, or 0.92 times or more with respect to the melting point (° C.) of alloy 10. The heating temperature of alloy 10 may be less than 1 times, 0.99 times or less, 0.98 times or less, 0.97 times or less, or 0.96 times or less, and preferably 0.98 times or less with respect to the melting point (° C.) of alloy 10. By setting the heating temperature within the above range so that the alloy having a melting point equal to or less than the melting point of alloy 10 is not completely melted, deterioration of magnetic properties and deterioration of thermal conductivity due to compounding can be suitably suppressed, and at the same time, good mechanical properties of composite materials can also be achieved.

A pressure may be 200 MPa or more, 300 MPa or more, 400 MPa or more, 500 MPa or more, or 600 MPa or more, preferably 300 MPa or more, and more preferably 500 MPa or more. In addition, the pressure may be 1.5 GPa or less, or 1 GPa or less.

The heating time and the pressurization time may be 1 minute or more, 3 minutes or more, 5 minutes or more, 8 minutes or more, or 10 minutes or more, respectively. The heating time and the pressurization time may be 360 minutes or less, 180 minutes or less, 100 minutes or less, 50 minutes or less, 30 minutes or less, or 15 minutes or less, respectively.

### EXAMPLES

Hereinafter, the present disclosure will be described in more detail with reference to manufacturing examples, examples, and comparative examples, but the present disclosure is not limited to these examples.

### Manufacturing Example

A magnetic calorific composite material was manufactured by the following steps.

### (1) Precursor Preparation Step

Raw material powders of a single body element were prepared in a predetermined ratio, and a precursor of a magnetic calorific material was prepared by a suction casting method in an inert gas atmosphere. The raw material powders used had a purity of 4N. In addition, rare earths such as lanthanum (La), cerium (Ce), praseodymium (Pr), and neodymium (Nd) were weighed 10 atm % greater since they volatilized during dissolution.

### (2) Magnetic Calorific Material Preparation Step

The obtained precursor was subjected to heat treatment using a muffle furnace to prepare an intermediate material having a crystal structure NaZn₁₃. Specifically, in order to prevent volatilization of rare earth elements, a quartz tube was vacuum-sealed so that the degree of vacuum was 10 to 5 Torr, and heat treatment was performed at 1,100° C. to 1,200° C. for 12 to 36 hours to obtain an intermediate material. The obtained intermediate material was put into a tube furnace filled with hydrogen and heated to 180° C. to 250° C. to occlude hydrogen. By controlling the heat treatment temperature, the hydrogen occlusion amount can be changed and the Curie temperature can be arbitrarily controlled.

### (3) Pulverization Step

The magnetic calorific material and an alloy serving as a binder were placed in a ball mill container and pulverized at 300 rpm for 24 hours so that the particle size was D50=50±10 μm to obtain an alloy-containing magnetic calorific material powder. In the ball mill, a ceramic ball having a diameter of 3 mm was used. In addition, the alloy was a Sn-based alloy containing Sn as a main material, and an alloy having a particle size of 100 to 200 μm was used.

### (4) Compounding Step

The alloy-containing magnetic calorific material powder was pressurized and heated by a thermal press device to prepare a bulk-shaped (square with a side of 20 mm square and a thickness of 2 mm) magnetic calorific composite material. The heating temperature applied to the material was a temperature obtained by multiplying the melting point of the alloy by 0.95 so that the alloy would not completely melt, and the pressure was 500 MPa. The pressure was maintained at 500 MPa for 10 minutes and then slowly cooled to obtain a magnetic calorific composite material.

### Evaluation of Magnetic Calorific Composite Material

Thermal properties, mechanical properties, and magnetic properties of the magnetic calorific composite material were evaluated. Specifically, for the thermal properties, thermal conductivity was measured using a laser flash method thermal conductivity measuring device (LFA-502 manufactured by Kyoto Denshi Kogyo Co., Ltd.). In addition, for the mechanical properties, Vickers strength was measured using a Vickers hardness tester (DUH-211 manufactured by Shimadzu Corporation), and for the magnetic properties, the Curie temperature and a change in the magnetic entropy (magnetic calorific effect) at a time of 2T application were measured using a physical property measurement system (PPMS manufactured by Quantum Design Co., Ltd.).

### Example 1: Examination of Binder

In order to confirm the effectiveness of the magnetic calorific composite material of the present disclosure, a magnetic calorific composite material containing an alloy binder, a resin binder-containing composite material which is an existing composite material, and a magnetic calorific material sintered body not using a binder were prepared, and comparison in thermal properties and magnetic properties was performed.

For the magnetic calorific material, La(Fe_{0.89}Si_{0.11})₁₃H which is La₁₋ₐAₐ(Fe_{b}B_{c}Si_{1-b-c})₁₃H_{d} in which a=0, b=0.89, c=0, d=1.0 was used commonly in Example 1-1 and Comparative Examples 1-1 to 1-2.

In Example 1-1, a magnetic calorific composite material was obtained using a dual system of SnIn as a binder and a magnetic calorific material obtained by the predetermined preparation method. A ratio of the alloy as the binder was 15 wt %.

In Comparative Example 1-1, the magnetic calorific material obtained by the predetermined preparation method was kneaded with a two-component curable epoxy resin to prepare a resin binder-containing composite material. The ratio of the epoxy resin as the binder was 15 wt %.

In Comparative Example 1-2, the magnetic calorific material obtained by the preparation method was sintered for 2 hours by the SPS method (plasma sintering method) to obtain a magnetic calorific material sintered body.

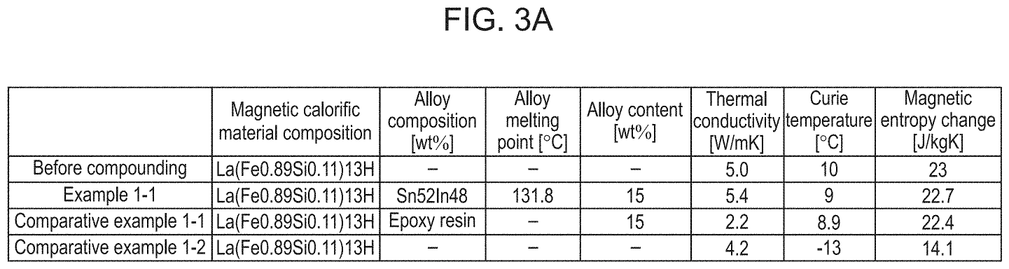

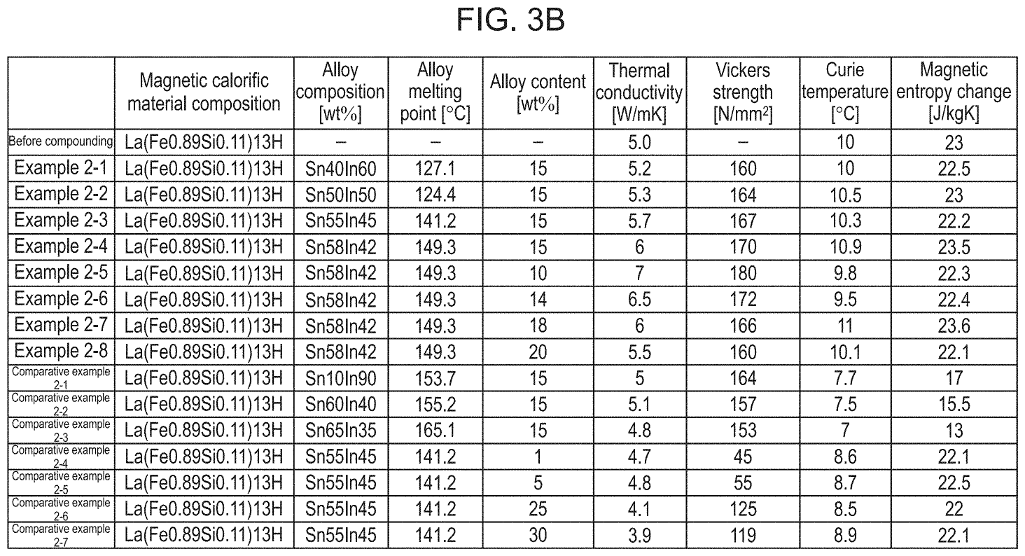

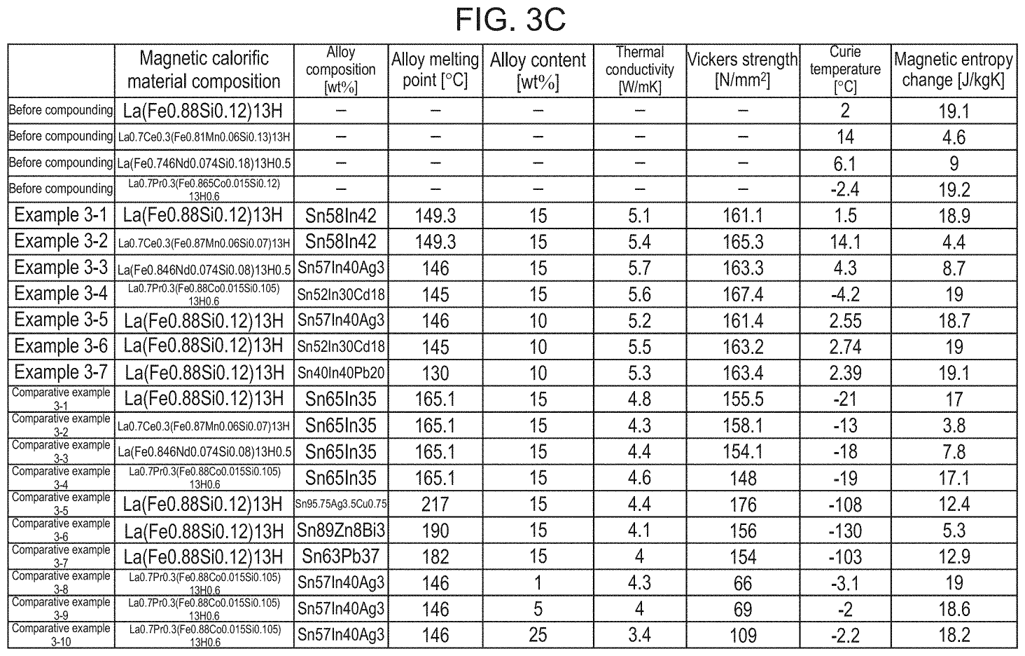

FIG. 3A shows results of comparative verification of the thermal properties and magnetic properties of Example 1-1, and Comparative Examples 1-1 and 1-2, respectively.

Various properties of the magnetic calorific material La(Fe_{0.89}Si_{0.1})₁₃H before compounding as the reference are as follows.

Thermal conductivity=5.0 W/kg

Curie temperature=10° C.

Magnetic entropy change (2T application)=23 J/kgK

It is preferable that properties after compounding are not significantly decreased from the numerical values.

In Example 1-1, deterioration of the thermal properties and the magnetic properties due to the compounding was not caused.

On the other hand, in Comparative Example 1-1, which is a resin binder-containing composite material, the magnetic properties were not deteriorated, but the thermal conductivity was significantly deteriorated.

In addition, in Comparative Example 1-2, which is a magnetic calorific material sintered body, both the thermal properties and the magnetic properties were not sufficient. It is considered that this is because a binder was not used, a space is generated inside the sintered body, and this served as thermal resistance to deteriorate the thermal conductivity. In addition, it is considered that since it was in a high temperature state of 600° C. or higher during SPS sintering, the magnetic properties were deteriorated due to the precipitation of a-Fe.

### Example 2: Examination of Melting Point and Content of Alloy

In order to confirm the effectiveness of the melting point and the content of the alloy, the melting point and the content of the alloy were changed, and a magnetic calorific composite material was prepared and evaluated.

Similar to Example 1, for the magnetic calorific material, La(Fe_{0.89}Si_{0.11})₁₃H which is La₁₋ₐAₐ(Fe_{b}B_{c}Si_{1-b-c})₁₃H_{d} in which a=0, b=0.89, c=0, d=1.0 was used.

In addition, for the alloy, a dual system of SnIn was used, and the melting point was controlled by changing a ratio of composition ratio Sn to 10 to 65 wt % and changing a ratio of In to 35 to 90 wt %.

FIG. 3B shows results of evaluating thermal properties, mechanical properties, and magnetic properties of the prepared magnetic calorific composite material.

Various properties of the magnetic calorific material La(Fe_{0.89}Si_{0.11})₁₃H before compounding as a reference are as follows (similar to Example 1).

Thermal conductivity=5.0 W/kg

Curie temperature=10° C.

Magnetic entropy change (2T application)=23 KJ/kgK

In addition, regarding the mechanical properties of the composite material, the mechanical strength as a reference is as follows, as the strength that is not destroyed by the flow of a refrigerant when the system is mounted.

Vickers strength=160 [N/mm²]

It is preferable that the properties after compounding are not significantly decreased from the reference value.

From Examples 2-1 to 2-4, it is recognized that it is possible to form a magnetic calorific composite material that maintains thermal conductivity and has little deterioration in magnetic properties in a case where the melting point of the alloy is 150° C. or lower.

On the other hand, in view of Comparative Examples 2-1 to 2-4, the magnetic properties are deteriorated. It is considered that this is because a compounding temperature rises by using an alloy exceeding 150° C., and deterioration of magnetic properties due to the precipitation of a-Fe (a iron) is generated.

It is recognized that in Examples 2-5 to 2-8, it is possible to form a composite material that maintains thermal conductivity and has little deterioration in magnetic properties. On the other hand, in Comparative Example 2-1 having an alloy binder content of 1 wt % and Comparative Example 2-2 having an alloy binder content of 5 wt %, the magnetic properties were not deteriorated but the mechanical strength was lowered. It is considered that this is because the content of the alloy was low, the adhesive effect as a binder was not obtained, and thus the mechanical strength was deteriorated.

### Example 3: Examination of Composition

In order to confirm the effectiveness of the types of the magnetic calorific material and the alloy, the magnetic calorific material and the alloy were changed to prepare a magnetic calorific material complex.

The details of the prepared magnetic calorific material complex will be described below.

### Example 3-1

For the magnetic calorific material, La(Fe_{0.89}Si_{0.11})₁₃H which is La₁₋ₐAₐ(Fe_{b}B_{c}Si_{1-b-c})₁₃H_{d} in which a=0, b=0.88, c=0, d=1.0 was used, and the alloy content of 15 wt % and Sn₅₈In₄₂ were used to prepare a magnetic calorific material complex by the predetermined preparation method.

### Example 3-2

For the magnetic calorific material, La_{0.7}Ce_{0.3}(Fe_{0.87}Mn_{0.06}Si_{0.07})₁₃H which is La₁₋ₐAₐ(Fe_{b}B_{c}Si_{1-b-c})₁₃H_{d} in which A=cerium (Ce), B=manganese (Mn), a=0.3, b=0.87, c=0.06, d=1.0 was used, and the alloy content of 15 wt % and Sn₅₈In₄₂ were used to prepare a magnetic calorific material complex by the predetermined preparation method.

### Example 3-3

For the magnetic calorific material, La(Fe_{0.846}Nd_{0.074}Si_{0.08})₁₃H_{0.5} which is La₁₋ₐAₐ(Fe_{b}B_{c}Si_{1-b-c})₁₃H_{d} in which B=neodymium (Nd), a=0, b=0.846, c=0.074, d=0.5 was used, and the alloy content of 15 wt % and Sn₅₇In₄₀Ag₃ were used to prepare a magnetic calorific material complex by the predetermined preparation method.

### Example 3-4

For the magnetic calorific material, La_{0.7}Pr_{0.3}(Fe_{0.8}Co_{0.015}Si_{0.105})₁₃H_{0.5} which is La₁₋ₐAₐ(Fe_{b}B_{c}Si_{1-b-c})₁₃H in which A=praseodymium (Pr), B=cobalt (Co), a=0.3, b=0.88, c=0.015, d=0.6 was used, the alloy content of 15 wt % and Sn₅₂In₃₀Cd₁₈ were used to prepare a magnetic calorific material complex by the predetermined preparation method.

### Example 3-5

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 10 wt % and Sn₅₇In₄₀Ag₃ were used to prepare a magnetic calorific material complex by the predetermined preparation method.

### Example 3-6

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 10 wt % and Sn₅₂In₃₀Cd₁₈ were used to prepare a magnetic calorific material complex by the predetermined preparation method.

### Example 3-7

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 10 wt % and Sn₄₀In₄₀Pb₂₀ were used to prepare a magnetic calorific material complex by the predetermined preparation method.

### Comparative Example 3-1

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 15 wt % and Sn₆₅In₃₅ were used to prepare a magnetic calorific material complex by the predetermined preparation method.

### Comparative Example 3-2

For the magnetic calorific material, La_{0.7}Ce_{0.3}(Fe_{0.87}Mn_{0.06}Si_{0.07})₁₃H which is La₁₋ₐAₐ(Fe_{b}B_{c}Si_{1-b-c})₁₃H_{d} in which A=cerium (Ce), B=manganese (Mn), a=0.3, b=0.87, c=0.06, d=1.0 was used, and the alloy content of 15 wt % and Sn₆₅In₃₅ were used to prepare a magnetic calorific material complex by the predetermined preparation method.

### Comparative Example 3-3

For the magnetic calorific material, La(Fe_{0.846}Nd_{0.074}Si_{0.08})₁₃H_{0.5} which is La₁₋ₐAₐ(Fe_{b}B_{c}Si_{1-b-c})₁₃H_{d} in which B=neodymium (Nd), a=0, b=0.846, c=0.074, d=0.5 was used, and the alloy content of 15 wt % and Sn₆₅In₃₅ were used to prepare a magnetic calorific material complex by the predetermined preparation method.

### Comparative Example 3-4

For the magnetic calorific material, La_{0.7}Pr_{0.3} (Fe_{0.88}Co_{0.015}Si_{0.105})₁₃ H_{0.6} which is La₁₋ₐAₐ(Fe_{b}B_{c}Si_{1-b-c})₁₃H_{d} in which A=praseodymium (Pr), B=cobalt (Co), a=0.3, b=0.88, c=0.015, and d=0.6 was used, and the alloy content of 15 wt % and Sn₆₅In₃₅ were used to prepare a magnetic calorific material complex by the predetermined preparation method.

### Comparative Example 3-5

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 15 wt % and Sn_{95.75}Ag_{3.5}Cu_{0.75} were used to prepare a magnetic calorific material complex by the predetermined preparation method.

### Comparative Example 3-6

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 15 wt % and Sn₈₉Zn₈Bi₃ were used to prepare a magnetic calorific material complex by the predetermined preparation method.

### Comparative Example 3-7

For the magnetic calorific material, La(Fe_{0.88}Si_{0.12})₁₃H which is La₁₋ₐAₐ(Fe_{b}B_{c}Si_{1-b-c})₁₃H_{d} in which a=0, b=0.88, c=0, d=1.0 was used, and the alloy content of 15 wt % and Sn₆₃Pb₃₇ were used to prepare a magnetic calorific material complex by the predetermined preparation method.

### Comparative Example 3-8

For the magnetic calorific material, La_{0.7}Pr_{0.3} (Fe_{0.88}Co_{0.015}Si_{0.105})₁₃ H_{0.6} which is La₁₋ₐAₐ(Fe_{b}B_{c}Si_{1-b-c})₁₃H_{d} in which A=praseodymium (Pr), B=cobalt (Co), a=0.3, b=0.88, c=0.015, d=0.6 was used, and the alloy content of 1 wt % and Sn₅₇In₄₀Ag₁₃ were used to prepare a magnetic calorific material complex by the predetermined preparation method.

### Comparative Example 3-9

For the magnetic calorific material, La_{0.7}Pr_{0.3} (Fe_{0.88}Co_{0.015}Si_{0.105})₁₃ H_{0.6} which is La₁₋ₐAₐ(Fe_{b}B_{c}Si_{1-b-c})₁₃H_{d} in which A=praseodymium (Pr), B=cobalt (Co), a=0.3, b=0.88, c=0.015, d=0.6 was used, and the alloy content of 5 wt % and Sn₅₇In₄₀Ag₃ were used to prepare a magnetic calorific material complex by the predetermined preparation method.

### Comparative Example 3-10

For the magnetic calorific material, La_{0.7}Pr_{0.3} (Fe_{0.88}Co_{0.015}Si_{0.16})₁₃ H_{0.6} which is La₁₋ₐAₐ(Fe_{b}B_{c}Si_{1-b-c})₁₃H_{d} in which A=praseodymium (Pr), B=cobalt (Co), a=0.3, b=0.88, c=0.015, d=0.6 was used, and the alloy content of 25 wt % and Sn₅₇In₄₀Ag₃ were used to prepare a magnetic calorific material complex by the predetermined preparation method.

Regarding the thermal conductivity and the mechanical properties as the reference in Example 3 are as follows, similar to Example 2.

Thermal conductivity=5.0 W/kg

Vickers strength=160 N/mm 2

The magnetic properties are as follows for each type of magnetic calorific material based on the magnetic properties of the magnetic calorific material before compounding as a reference.

La(Fe_{0.88}Si_{0.12})H:

Curie temperature=2° C.

Magnetic entropy change=19.1 J/kgK

La_{0.7}Ce_{0.3}(Fe_{0.81}Mn_{0.06}Si_{0.13})₁₃H:

Curie temperature=14° C.

Magnetic entropy change 4.6 J/kgK

La(Fe_{0.746}Nd_{0.074}Si_{0.18})₁₃H_{0.5:}

Curie temperature=6.1° C.

Magnetic entropy change 9 J/kgK

La_{0.7}Pr_{0.3}(Fe_{0.865}Co_{0.015}Si_{0.12})₁₃H_{0.6}:

Curie temperature=−2.4° C.

Magnetic entropy change 19.2 J/kgK

It is preferable that the properties after compounding are not significantly decreased from the reference value.

FIG. 3C shows the results of measuring the thermal conductivity, Vickers strength, Curie temperature, and change in magnetic entropy.

Examples 3-1 to 3-7 have good thermal conductivity, Vickers strength, Curie temperature, and magnetic entropy change. It can be said that the effect of maintaining the thermal conductivity and suppressing deterioration of the magnetic properties was achieved regardless of the difference in the composition of the magnetic calorific material or the type of the alloy.

In addition, regardless of the composition difference of magnetic calorific material 8 as in Comparative Examples 3-1 to 3-7, in a case where a composite material is prepared using an alloy having a melting point of 150° C. or higher, it is recognized that the magnetic properties are significantly deteriorated. It is considered that this is because the magnetic properties were deteriorated due to the precipitation of a-Fe (a iron) at the time of compounding as in Example 2. In addition, it is recognized that the magnetic properties of the alloy Sn₈₉Zn₈Bi used in Comparative Example 3-6 are particularly significantly deteriorated. It is considered that this is because the magnetic calorific material lanthanum (La) and the alloy bismuth (Bi) are reacted.

In view of Comparative Examples 3-8 to 3-10 in which the content was changed, it is recognized that since an alloy having a low melting point is used, the magnetic properties are not deteriorate but the mechanical properties are below the reference. It is considered that Comparative Examples 3-8 and 3-9 having a small proportion of alloys did not have an adhesive effect as a binder and the mechanical strength was lowered since the amount of alloys was small. In Comparative Example 3-10 having many alloys, it is considered that the thermal conductivity was lowered since the binder component was larger than that of magnetic calorific material 8.

As described above, it was recognized that in a case where the melting point of the alloy used in the composite material using a LaFeSi-based magnetic calorific material is 150° C. or lower and the content is 10 to 20 wt %, the thermal conductivity of the composite material is maintained and the deterioration of magnetic properties is suppressed.

A magnetic calorific composite material of a first aspect of the present disclosure may include: a magnetic calorific material, and an alloy binder having a melting point in a range of 100° C. to 150° C., in which a content of the alloy binder may be 7.5 wt % to 22.5 wt %.

In a magnetic calorific composite material of a second aspect of the present disclosure, the magnetic calorific material of the first aspect may be a La (FeSi)₁₃-based material.

In the magnetic calorific composite material of a third aspect of the present disclosure, the magnetic calorific material of the first or second aspect may be represented by Formula ( ):

La₁₋ₐAₐ(Fe_{b}B_{c}Si_{1-b-c})₁₃H_{d} (I)

in Formula (I),

A may be at least one selected from the group consisting of cerium (Ce), praseodymium (Pr), and neodymium (Nd), which are rare earth elements, B may be at least one selected from the group consisting of manganese (Mn) and cobalt (Co), which are 3d transition elements, and the magnetic calorific composite material has a NaZn₁₃-type crystal structure satisfying the relationships of

0≤a≤0.5,

0.75≤b≤0.95,

0≤c≤0.3,

0.1≤d≤2.0, and

0.05≤1−b−c≤0.2.

In a magnetic calorific composite material of a fourth aspect of the present disclosure, the alloy binder of the first to third aspects may be an alloy containing Sn and one or two or more selected from the group consisting of In, Ag, Pb, and Cd.

In the magnetic calorific composite material of a fifth aspect of the present disclosure, the alloy binder of the first to fourth aspects may contain 40 wt % or more of Sn.

A method for manufacturing the magnetic calorific composite material of a sixth aspect of the present disclosure may be a method of manufacturing a magnetic calorific composite material containing a magnetic calorific material and an alloy binder having a melting point in a range of 100° C. to 150° C., the method including: pressurizing a mixture of the magnetic calorific material and the alloy binder at a temperature in the range of 100° C. to 150° C. of the melting point of the alloy binder.

A method for manufacturing a magnetic calorific composite material of a seventh aspect of the present disclosure may include pressurizing the mixture at a temperature in a range of 0.75 times or more and less than 1 times the melting point of the alloy binder, in the sixth aspect.

A method for manufacturing a magnetic calorific composite material of an eighth aspect of the present disclosure may include pressurizing the mixture at 300 MPa or more in the sixth or seventh aspect.

According to the present disclosure, it is possible to achieve suppression of a decrease in the thermal conductivity of the magnetic calorific composite material and a decrease in the magnetic calorific effect due to compounding.

Since the magnetic calorific composite material prepared by the manufacturing method of the present disclosure is capable of exhibiting mechanical strength and thermal conductivity of the composite material while preventing deterioration of magnetic properties, it is possible to realize high output and miniaturization of the magnetic refrigeration system and to apply thereof to household refrigerators and air conditioning.

What is claimed is:

1. A magnetic calorific composite material comprising:
a magnetic calorific material; and
an alloy binder having a melting point in a range of 100° C. to 150° C.,
wherein a content of the alloy binder is 7.5 wt % to 22.5 wt %.

2. The magnetic calorific composite material of claim 1,
wherein the magnetic calorific material is a La(FeSi)₁₃-based material.

3. The magnetic calorific composite material of claim 1,
wherein the magnetic calorific material is represented by Formula (I):
La₁₋ₐAₐ(Fe_{b}B_{c}Si_{1-b-c})₁₃H_{d} (I)
in Formula (I),
A is at least one selected from the group consisting of cerium (Ce), praseodymium (Pr), and neodymium (Nd), which are rare earth elements, B is at least one selected from the group consisting of manganese Mn) and cobalt (Co), which are 3d transition elements, and the magnetic calorific composite material has a NaZn₁₃-type crystal structure satisfying the relationships of
0≤a≤0.5,
0.75≤b≤0.95,
0≤c≤0.3,
0.1≤d≤2.0, and
0.05≤1−b−c≤0.2.

4. The magnetic calorific composite material of claim 1,
wherein the alloy binder is an alloy containing Sn and one or two or more selected from the group consisting of In, Ag, Pb, and Cd.

5. The magnetic calorific composite material of claim 1,
wherein the alloy binder contains 40 wt % or more of Sn.

6. A method for manufacturing a magnetic calorific composite material containing a magnetic calorific material and an alloy binder having a melting point in a range of 100° C. to 150° C., the method comprising:
pressurizing a mixture of the magnetic calorific material and the alloy binder at a temperature in the range of 100° C. to 150° C. of the melting point of the alloy binder.

7. The method for manufacturing a magnetic calorific composite material of claim 6, the method comprising:
pressurizing the mixture at a temperature in a range of 0.75 times or more and less than 1 times the melting point of the alloy binder.

8. The method for manufacturing a magnetic calorific composite material of claim 6, the method comprising:
pressurizing the mixture at 300 MPa or more.
